(19) United States
(12) Patent Application Publication
(10) Pub. No.: US 2020/0006752 A1
(43) Pub. Date: Jan. 2, 2020

(54) REDISPERSIBLE PARTICLES BASED ON SILICON PARTICLES AND POLYMERS

(71) Applicant: WACKER CHEMIE AG, München (DE)

(72) Inventors: Rebecca Bernhard, München (DE); Dominik Jantke, Burghausen (DE)

(21) Appl. No.: 16/484,815

(22) PCT Filed: Feb. 9, 2017
(86) PCT No.: PCT/EP2017/052864

§ 371 Date: Aug. 8, 2019

(51) Int. Cl. H01M 4/134; H01M 4/04; H01M 4/38; H01M 10/0525

(52) U.S. Cl. CPC H01M 4/134; H01M 4/0471; H01M 2004/027; H01M 10/0525; H01M 4/386

(57) ABSTRACT

The invention relates to methods for producing redispersible particles based on silicon particles and polymers, characterised in that a) mixtures containing silicon particles with average particle diameter d₅₀ of >600 nm, one or more polymer containing functional groups selected from the group comprising carboxyl-, ester-, alkoxy-, amide-, imide- und hydroxy-groups, as well as one or more solvents are dried; and subsequently b) a thermal treatment is carried out at a temperature of 80° C. until below the decomposition temperature of the polymers.

The invention relates to redispersible particles based on silicon particles and polymers, processes for the production thereof and also the use thereof for producing electrode materials for lithium ion batteries, in particular for producing the negative electrodes of lithium ion batteries.

Rechargeable lithium ion batteries are today the practical electrochemical energy stores having the highest gravimetric energy densities. Silicon has a particularly high theoretical material capacity (4200 mAh/g) and is therefore particularly suitable as active material for anodes of lithium ion batteries. Anodes are produced by means of anode inks in which the individual constituents of the anode material are dispersed in a solvent. On the industrial scale, water is usually used as solvent for this purpose for economic and ecological reasons. However, the surface of silicon is very reactive toward water and on contact with water is oxidized to form silicon oxides and hydrogen. The liberation of hydrogen leads to considerable difficulties in processing of the anode inks. For example, such inks can give inhomogeneous electrode coatings because of included gas bubbles. In addition, the formation of hydrogen makes complicated safety precautions necessary. Finally, undesirable oxidation of silicon also leads to a reduction in the proportion of silicon in the anode, which reduces the capacity of the lithium ion battery.

To reduce the formation of hydrogen in the processing of aqueous anode inks, Touidjine (Journal of The Electrochemical Society, 2015, 162, pages A1466 to A1475) teaches firstly oxidizing the surface of the silicon particles in a targeted manner by pretreatment with water or air at elevated temperatures and only then incorporating the silicon particles which have been treated in this way into aqueous anode inks. Touidjine describes aggregated silicon particles having average particle sizes of 150 nm and specific BET surface areas of 14 m²/g. After oxidation by means of air, the silicon particles have an SiO₂ content of 11% by weight. The high oxygen content of the particles inevitably leads to a low proportion of elemental silicon. Proportions of silicon dioxide of such a magnitude lead to high initial capacity losses.

K. Zaghib, Hydro-Quebec, has presented a series of alternative approaches for reducing the formation of hydrogen from aqueous silicon particle dispersions for discussion, for example coating of the surfaces of the silicon particles or addition of pH-controlling additives or oxidation of the surface of the silicon particles or aging of the silicon particles, in a lecture (Conference DoE Annual Merit Review, Jun. 6 to 10, 2016, Washington D.C. USA, paper es222).

Lithium ion batteries having anode materials containing silicon particles are also known from EP1313158. The silicon particles of EP1313158 have average particle sizes of from 100 to 500 nm. Relatively large particle sizes are considered to be disadvantageous for the coulombic efficiency of corresponding batteries. The particles were produced by milling and subsequent oxidative treatment with oxygen-containing gases or subsequent coating with polymers. In the case of polymer coating, EP1313158 also recommends polymerizing ethylenically unsaturated monomers in the presence of silicon particles.

DE102015215415.7 (application number) describes the use of silicon particles having a volume-weighted particle size distribution of d₁₀≥0.2 μm and d₉₀≤20.0 μm and also a breadth d₉₀−d₁₀≤15 μm in anode materials for lithium ion batteries.

In the light of this background, it was an object of the present invention to provide silicon particles which when used in aqueous ink formulations for producing anodes for lithium ion batteries do not lead to any formation of hydrogen, or lead to only very little formation of hydrogen, in particular do not cause any foaming of aqueous ink formulations or do not bring about any poor pumpability of inks, and in addition allow the advantageous introduction of very high proportions of silicon into the anodes and also give very homogeneous anode coatings. The object should preferably also be achieved for ink formulations having neutral pH values. In addition, an improvement in the electrochemical performance of corresponding lithium ion batteries having anodes containing silicon particles should also be achieved if possible.

The invention provides processes for producing redispersible particles based on silicon particles and polymers, characterized in that

a) mixtures containing silicon particles having average particle diameters d₅₀ of >600 nm, one or more polymers containing functional groups selected from the group consisting of carboxyl, ester, alkoxy, amide, imide and hydroxy groups and also one or more solvents are dried and

b) a thermal treatment is then carried out at a temperature of from 80° C. to below the decomposition temperature of the polymers.

The invention further provides redispersible particles based on silicon particles and polymers obtainable by the abovementioned process of the invention.

The redispersible particles from step b) of the process of the invention are generally polymer-coated silicon particles. As a result of the thermal treatment in step b), the polymers are joined to the silicon particles in an advantageous way. This is manifested, for example, by the particles obtained in step b) being stable after redispersion in water at room temperature and pH 7 and liberating essentially no polymers. The products from step b) can therefore also be classified as stable to washing off. On the other hand, the dried products from step a) separate entirely or at least partly into their initial constituents, namely into silicon particles and polymers, under such conditions. Without wishing to be tied to a theory, such bonding could occur via covalent bonds between the polymers and the surface of the silicon particles, for example via silyl ester bonds or by crosslinking of the polymers.

The polymers preferably contain one or more functional groups selected from the group consisting of carboxyl and hydroxy groups. Carboxyl groups are most preferred.

Preferred polymers are cellulose, cellulose derivatives, polymers based on ethylenically unsaturated monomers, e.g. polyacrylic acid or polyvinyl esters, in particular homopolymers or copolymers of vinyl acetate, polyamides, polyimides, in particular polyamidimides, and polyvinyl alcohols. Particularly preferred polymers are polyacrylic acid or salts thereof and in particular cellulose or cellulose derivatives, e.g. carboxymethyl cellulose. Cellulose or cellulose derivatives, in particular carboxymethyl cellulose, are most preferred. Salts of polymers bearing carboxylic acid groups are also preferred. Preferred salts are alkali metal salts, in particular lithium, sodium or potassium salts.

The polymers containing functional groups are preferably soluble in the solvents. The polymers are preferably soluble therein to an extent of more than 5% by weight under standard conditions (23/50) in accordance with DIN50014.

The mixtures in step a) preferably contain ≤95% by weight, more preferably ≤50% by weight, even more preferably ≤35% by weight, particularly preferably ≤20% by weight, and most preferably ≥10% by weight and especially preferably ≤5% by weight, of polymers. The mixtures in step a) preferably contain ≥0.05% by weight, particularly preferably ≥0.3% by weight and most preferably ≥1% by weight, of polymers. The abovementioned figures in percent by weight are in each case based on the dry weight of the mixtures in step a).

The volume-weighted particle size distribution of the silicon particles has diameter percentiles d₅₀ of preferably from 650 nm to 15.0 μm, more preferably from 700 nm to 10.0 μm, even more preferably from 700 nm to 7.0 μm, particularly preferably from 750 nm to 5.0 μm and most preferably from 800 nm to 2.0 μm.

The volume-weighted particle size distribution of the silicon particles has diameter percentiles d₁₀ of preferably from 0.5 μm to 10 μm, particularly preferably from 0.5 μm to 3.0 μm and most preferably from 0.5 μm to 1.5 μm.

The volume-weighted particle size distribution of the silicon particles has diameter percentiles d₉₀ of preferably from 2.0 μm to 20.0 μm, particularly preferably from 3.0 to 15.0 μm and most preferably from 5.0 μm to 10.0 μm.

The volume-weighted particle size distribution of the silicon particles has a breadth d₉₀−d₁₀ of preferably ≤20.0 μm, more preferably ≤15.0 μm, even more preferably ≤12.0 μm, particularly preferably ≤10.0 μm and most preferably ≤7.0 μm.

The volume-weighted particle size distribution of the silicon particles can be determined by static laser light scattering using the Mie model and the measuring instrument Horiba LA 950 using alcohols, for example ethanol or isopropanol, or preferably water as dispersion medium for the silicon particles.

The silicon particles are preferably not agglomerated, particularly preferably not aggregated.

Aggregated means that spherical or largely spherical primary particles as are, for example, initially formed in gas-phase processes in the production of the silicon particles have grown together to form aggregates. Aggregation of primary particles can, for example, occur during the production of the silicon particles in gas-phase processes. Such aggregates can form agglomerates in the further course of the reaction. Agglomerates are a loose assembly of aggregates. Agglomerates can easily be broken up again into the aggregates by means of kneading and dispersing processes which are typically used. Aggregates cannot be broken up, or can be broken up to only a small extent, into the primary particles by means of these methods. Due to the way in which they are formed, aggregates and agglomerates inevitably have quite different sphericities and particle shapes than the preferred silicon particles. The presence of silicon particles in the form of aggregates or agglomerates can, for example, be made visible by means of conventional scanning electron microscopy (SEM). Static light scattering methods, on the other hand, for determining the particle size distributions or particle diameters of silicon particles cannot distinguish between aggregates or agglomerates.

The BET surface areas of the silicon particles are preferably from 0.2 to 30.0 m²/g, particularly preferably from 0.5 to 20.0 m²/g and most preferably from 1.0 to 15.0 m²/g. The BET surface area is determined in accordance with DIN 66131 (using nitrogen).

The silicon particles preferably have splinter-like particle shapes. The silicon particles have a sphericity of preferably 0.3≤ψ≤0.9, particularly preferably 0.5≤ψ≤0.85 and most preferably 0.65≤ψ≤0.85. Silicon particles having such sphericities are obtainable, in particular, by production by means of milling processes. The sphericity 4, is the ratio of the surface area of a sphere of the same volume to the actual surface area of a body (definition of Wadell). Sphericities can, for example, be determined from conventional SEM images.

The silicon particles are preferably based on elemental silicon. For the purposes of the present invention, elemental silicon is high-purity, polycrystalline silicon having a small proportion of foreign atoms (for example B, P, As), silicon deliberately doped with foreign atoms (for example B, P, As) or else silicon from metallurgical processing, which can have elemental contamination (for example Fe, Al, Ca, Cu, Zr, Sn, Co, Ni, Cr, Ti, C).

If the silicon particles contain a silicon oxide, the stoichiometry of the oxide SiOₓ is preferably in the range 0<x<1.3. If the silicon particles contain a silicon oxide having a higher stoichiometry, the layer thickness of this on the surface is preferably less than 10 nm.

When the silicon particles are alloyed with an alkali metal M, the stoichiometry of the alloy M_{y}Si is preferably in the range 0<y<5. The silicon particles can optionally be prelithiated. If the silicon particles are alloyed with lithium, the stoichiometry of the alloy Li_{z}Si is preferably in the range 0<z<2.2.

Particular preference is given to silicon particles which contain ≥80 mol % of silicon and/or ≤20 mol % of foreign atoms, very particularly preferably ≤10 mol % of foreign atoms.

The surface of the silicon particles can optionally be covered by an oxide layer or by other inorganic and organic groups. Particularly preferred silicon particles bear Si—OH or Si—H groups or covalently bound organic groups, for example alcohols or alkanes, on the surface. The surface tension of the silicon particles, for example, can be controlled by means of the organic groups. It can in this way be matched to the solvents or polymers which are used in the production of the redispersible particles or in the production of the electrode coatings. Surfaces of the silicon particles which have been occupied in such a way can be useful for linking the polymers and the silicon particles to give more stable redispersible particles according to the invention.

The silicon particles can, for example, be produced by means of vapor deposition or preferably by milling processes.

Possible milling processes are, for example, dry milling processes or preferably wet milling processes. Here, preference is given to using planetary ball mills, jet mills such as opposed jet or impingement mills, or stirred ball mills.

Wet milling is generally carried out in a suspension comprising organic or inorganic dispersion media. It is also possible to choose the solvents mentioned for step a) as dispersion media.

The mixtures in step a) preferably contain ≥5% by weight, more preferably ≥50% by weight, even more preferably ≥65% by weight, particularly preferably ≥80% by weight, most preferably ≥90% by weight and especially preferably 95% by weight, of silicon particles. The mixtures in step a) preferably contain ≤99.95% by weight, particularly preferably ≤99.7% by weight and most preferably ≤99% by weight, of silicon particles. The abovementioned figures in percent by weight are in each case based on the dry weight of the mixtures in step a).

As solvents in step a), it is possible to use organic and/or inorganic solvents. It is also possible to use mixtures of two or more solvents. An example of an inorganic solvent is water. Organic solvents are, for example, hydrocarbons, esters or preferably alcohols. The alcohols preferably contain from 1 to 7 and particularly preferably from 2 to 5 carbon atoms. Examples of alcohols are methanol, ethanol, propanol, butanol and benzyl alcohol. Preference is given to ethanol and 2-propanol. Hydrocarbons preferably contain from 5 to 10 and particularly preferably from 6 to 8 carbon atoms. Hydrocarbons can, for example, be aliphatic or aromatic. Examples of hydrocarbons are toluene and heptane. Esters are generally esters of carboxylic acids and alkyl alcohols, for example ethyl acetate.

Preferred solvents are water or mixtures of water and one or more organic solvents, in particular alcohols. Preferred solvent mixtures contain water in an amount of preferably from 10 to 90% by weight, particularly preferably from 30 to 80% by weight and most preferably from 50 to 70% by weight. Preferred solvent mixtures preferably contain from 10 to 90% by weight, particularly preferably from 20 to 70% by weight and most preferably from 30 to 50% by weight, of organic solvents, in particular alcohols. The abovementioned figures in percent by weight are in each case based on the total weight of the solvents in the mixtures in step a).

The mixtures in step a) preferably contain ≥10% by weight, more preferably ≥30% by weight, particularly preferably ≥50% by weight and most preferably ≥70% by weight, of solvents. The mixtures in step a) preferably contain ≤99.8% by weight, particularly preferably ≤95% by weight and most preferably ≤90% by weight, of solvents. The abovementioned figures in percent by weight are in each case based on the total weight of the mixtures in step a).

In step a), one or more binders can optionally be used in addition. Examples of such binders are polyalkylene oxides such as polyethylene glycol, polyvinylidene fluoride, polytetrafluoroethylene, polyolefins or thermoplastic elastomers, in particular ethylene-propylene-diene terpolymers. For clarity, it may be said that such binders are different from the polymers containing functional groups which are used in step a). The proportion of such binders is preferably ≤30% by weight and particularly preferably ≤10% by weight, based on the total weight of polymers and binders in step a). Preference is most of all given to not using any binders in addition.

The mixtures in step a) can additionally contain one or more electrically conductive components and/or one or more additives.

Examples of electrically conductive components are graphite particles, conductive carbon black, carbon nanotubes or metallic particles, for example copper particles. The mixtures in step a) preferably do not contain any electrically conductive components, in particular do not contain any graphite.

Examples of additives are pore formers, leveling agents, dopants or materials which improve the electrochemical stability of the electrode in the battery.

The mixtures in step a) preferably contain from 0 to 30% by weight, particularly preferably from 0.01 to 15% by weight and most preferably from 0.1 to 5% by weight, of additives, based on the dry weight of the mixtures in step a). In a preferred, alternative embodiment, the mixtures in step a) do not contain any additives.

The production of the mixtures for step a) can be carried out by mixing the individual constituents thereof and is not tied to any particular procedure. Thus, silicon particles, polymers and solvents and also optional further components can be mixed in any order. The silicon particles and/or the polymers can be used in pure form or preferably in one or more solvents for mixing. The silicon particles are preferably used in the form of dispersions, in particular alcoholic dispersions. The polymers are preferably used in the form of solutions, in particular in the form of aqueous solutions. Further solvents or additional amounts of solvent can also be added for the mixing of silicon particles in the form of dispersions and/or polymers in the form of solutions. The polymers, optionally dissolved or dispersed in solvents, can also be added before, during or after milling, in particular wet milling, of a suspension containing silicon particles.

Mixing can be carried out in conventional mixing apparatuses, for example in rotor-stator machines, high-energy mills, planetary kneaders, stirred ball mills, shaking tables, dissolvers, sets of rollers or ultrasonic devices.

The mixtures used for drying in step a) are in a flowable state in an advantageous embodiment of the invention. The mixtures to be dried have a pH of preferably ≤7 (determined at 20° C., for example by means of the pH meter model WTW pH 340i with SenTix RJD probe).

The drying in step a) can, for example, be carried out by means of fluidized-bed drying, freeze drying, thermal drying, drying under reduced pressure, contact drying, convection drying or spray drying. Preference is given to vacuum contact drying, particularly preferably spray drying. The plants and conditions customary for this purpose can be employed.

Drying can be carried out in ambient air, synthetic air, oxygen or preferably in an inert gas atmosphere, for example in a nitrogen or argon atmosphere. In general, drying is carried out at atmospheric pressure or under reduced pressure. Drying is generally carried out at temperatures of ≤400° C., preferably ≤200° C. and particularly preferably ≤150° C. In a preferred embodiment, drying is carried out at temperatures of from −60° C. to 200° C.

Freeze drying is generally carried out at temperatures below the freezing point of the mixture to be dried, preferably at temperatures in the range from −120° C. to 0° C. and particularly preferably from −20° C. to −60° C. The pressure is preferably in the range from 0.005 to 0.1 mbar.

Drying under reduced pressure is preferably carried out at temperatures of from 40° C. to 100° C. and pressures of from 1 to 10⁻³ mbar, in particular from 100 to 10⁻³ mbar.

Spray drying can, for example, be carried out in spray drying plants in which atomization is effected by means of single-fluid, two-fluid or multifluid nozzles or by means of a rotating disk. The inlet temperature of the mixture to be dried into the spray drying plant is preferably greater than or equal to the boiling point of the mixture to be dried and particularly preferably ≥10° C. higher than the boiling point of the mixture to be dried. The inlet temperature is preferably from 80° C. to 200° C., particularly preferably from 100° C. to 150° C., for example. The outlet temperature is preferably ≥30° C., particularly preferably ≥40° C. and most preferably ≥50° C. In general, the outlet temperature is in the range from 30° C. to 100° C., preferably from 45° C. to 90° C. The pressure in the spray drying plant is preferably ambient pressure. In the spray drying plant, the sprayed mixtures have primary droplet sizes of preferably from 1 to 1000 μm, particularly preferably from 2 to 600 μm and most preferably from 5 to 300 μm. The size of the primary particles, the residual moisture content of the product and the yield of the product can be set in a manner known per se via the settings of the inlet temperature, the gas flow (flow) and the pumping rate (feed), the selection of the nozzle, of the aspirator, the choice of solvent or the solids concentration of the spray suspension. For example, primary particles having relatively large particle sizes are obtained at a higher solids concentration of the spray suspension; on the other hand, a higher spraying gas flow (flow) leads to smaller particle sizes.

In the other drying processes, drying is preferably carried out at temperatures of from 0° C. to 200° C., particularly preferably from 10° C. to 180° C. and most preferably from 30° C. to 150° C. The pressure in the other drying processes is preferably from 0.5 to 1.5 bar. Drying can, for example, be effected by contact with hot surfaces, convection or radiative heat. Preferred dryers for the other drying processes are fluidized-bed dryers, screw dryers, paddle dryers and extruders.

The mixtures from step a) are generally substantially freed of solvent in the drying operation. The products obtained after carrying out drying in step a) preferably contain ≤10% by weight, more preferably ≤5% by weight, even more preferably ≤3% by weight and most preferably ≤1% by weight, of solvents, based on the total weight of the dried products from step a).

The products from step a) are preferably redispersible particles, in particular particles which are redispersible in water. During redispersion, the dried products from step a) generally break up again into their initial constituents, in particular silicon particles and the polymers used according to the invention. The particles obtained in step a) are generally not coated with carbon. The silicon particles preferably take up ≤1% by weight of oxygen while step a) is being carried out (determined as indicated below under the heading “Determination of the oxygen content”). The silicon particles present in the dried product from step a) particularly preferably have substantially the same oxygen content as the silicon particles which were used for drying in step a).

The products from step a) are preferably used directly in step b). Step b) can also directly follow step a). The particles from step a) are thus preferably not treated further before introduction into step b).

The thermal treatment in step b) is carried out at a temperature below the decomposition temperature of the polymers. The decomposition temperature is the temperature above which a polymer undergoes a change in its chemical make-up as a result of thermal decomposition, for example by elimination of small molecules such as water or carbon dioxide. The decomposition can, for example, be indicated in a conventional way by means of thermogravimetric analysis (TGA).

The temperature for the thermal treatment is preferably ≥90° C., particularly preferably ≥100° C. and most preferably ≥110° C. The abovementioned temperature is preferably ≤250° C., more preferably ≤220° C., particularly preferably ≤200° C., even more preferably ≤180° C. and most preferably ≤160° C.

The thermal treatment in step b) can be carried out in ambient air, synthetic air, oxygen or in an inert gas atmosphere, for example in a nitrogen or argon atmosphere. Preference is given to air.

Step b) can be carried out under any pressures. Preference is given to working at a pressure of from 0.5 to 2 bar, in particular from 0.8 to 1.5 bar. The thermal treatment is particularly preferably carried out at ambient pressure.

The duration of the thermal treatment can be, for example, from 1 minute to 48 hours, preferably from 5 minutes to 30 hours, more preferably from 10 minutes to 24 hours and even more preferably from 30 minutes to 16 hours.

The thermal treatment can be carried out continuously or discontinuously. In the continuous mode of operation, the duration of the thermal treatment is preferably from 1 minute to 6 hours and particularly preferably from 5 minutes to 2 hours. In the discontinuous case, the duration is preferably from 1 to 48 hours, particularly preferably from 6 to 30 hours and most preferably from 12 to 24 hours.

The thermal treatment can be carried out in conventional reactors, for example in a calcination furnace, tube furnace, in particular a rotary tube furnace, fluidized-bed reactor, moving-bed reactor or a drying oven. Particular preference is given to calcination furnaces, fluidized-bed reactors and rotary tube furnaces.

Step b) is preferably carried out in the absence of liquids such as solvents, in particular in the absence of water or alcohols in liquid form.

The redispersible particles from step b) are preferably redispersible in water. The redispersible particles from step b) are preferably not agglomerated, particularly preferably not aggregated. The redispersible particles obtained in step b) are generally not coated with carbon.

The volume-weighted particle size distribution of the redispersible particles from step b) can be determined by static laser light scattering using the Mie model and the measuring instrument Horiba LA 950 using alcohols, for example ethanol or isopropanol, or preferably water as dispersion medium for the redispersible silicon particles. The particle size distributions determined in this way preferably have the following values for the diameter percentiles d₅₀, d₁₀, d₉₀ and d₉₀−d₁₀.

The volume-weighted particle size distribution of the redispersible particles from step b) has diameter percentiles d₅₀ of preferably from 650 nm to 15.0 μm, more preferably from 700 nm to 10.0 μm, even more preferably from 700 nm to 7.0 μm, particularly preferably from 750 nm to 5.0 μm and most preferably from 800 nm to 2.0 μm.

The volume-weighted particle size distribution of the redispersible particles from step b) has diameter percentiles d₁₀ of preferably from 0.5 μm to 10 μm, particularly preferably from 0.5 μm to 3.0 μm and most preferably from 0.5 μm to 1.5 μm.

The volume-weighted particle size distribution of the redispersible particles from step b) has diameter percentiles d₉₀ of preferably from 2.0 μm to 20.0 μm, particularly preferably from 3.0 μm to 15.0 μm and most preferably from 5.0 μm to 10.0 μm.

The volume-weighted particle size distribution of the redispersible particles from step b) has a breadth d₉₀−d₁₀ of preferably ≤20.0 μm, more preferably ≤15.0 μm, even more preferably ≤12.0 μm, particularly preferably ≤10.0 μm and most preferably ≤7.0 μm.

The BET surface areas of the silicon particles are preferably from 0.2 to 30.0 m²/g, particularly preferably from 0.5 to 20.0 m²/g and most preferably from 1.0 to 15.0 m²/g. The BET surface area is determined in accordance with DIN 66131 (using nitrogen).

The redispersible particles from step b) preferably have splinter-like particle shapes. The redispersible particles from step b) have a sphericity of preferably 0.3≤ψ≤0.9, particularly preferably 0.5≤ψ≤0.85 and most preferably 0.65≤ψ≤0.85. The sphericity ψ is the ratio of the surface area of a sphere of the same volume to the actual surface area of a body (definition of Wadell). Sphericities can, for example, be determined from conventional SEM images.

The redispersible particles from step b) preferably contain from 50 to 99.7% by weight, more preferably from 80 to 99.5% by weight, particularly preferably from 90 to 99% by weight and most preferably from 95 to 98.5% by weight, of silicon particles; and preferably from 0.3 to 50% by weight, more preferably from 0.5 to 20% by weight, particularly preferably from 1 to 10% by weight and most preferably from 1.5 to 5% by weight, of polymers; where the figures in percent by weight are in each case based on the total weight of the redispersible particles.

The silicon particles of the redispersible particles from step b) preferably contain from 0.2 to 6.0% by weight, particularly preferably from 1.0 to 4.0% by weight, of oxygen, based on the weight of the silicon particles of the redispersible particles from step b).

The products of step b) have, compared to the products from step a), a carbon content which is preferably from 0 to 1% by weight lower, particularly preferably from 0.15 to 0.5% by weight lower and most preferably from 0.2 to 0.4% by weight lower, in each case based on the total weight of the products (determined as indicated below under the heading “Determination of the carbon content”).

The invention further provides aqueous ink formulations containing one or more binders, optionally graphite, optionally one or more further electrically conductive components and optionally one or more additives, characterized in that redispersible particles from step b) of the process of the invention are present.

The invention further provides anode materials for lithium ion batteries which contain one or more binders, optionally graphite, optionally one or more further electrically conductive components and optionally one or more additives, characterized in that one or more redispersible particles from step b) of the process of the invention are present.

Preferred formulations for the anode material of the lithium ion batteries preferably contain from 5 to 95% by weight, in particular from 60 to 85% by weight, of redispersible particles from step b) of the process of the invention; from 0 to 40% by weight, in particular from 0 to 20% by weight, of further electrically conductive components; from 0 to 80% by weight, in particular from 5 to 30% by weight, of graphite; from 0 to 25% by weight, preferably from 1 to 20% by weight, particularly preferably from 5 to 15% by weight, of binders; and optionally from 0 to 80% by weight, in particular from 0.1 to 5% by weight, of additives; where the figures in percent by weight are based on the total weight of the anode material and the proportions of all constituents of the anode material add up to 100% by weight.

In a preferred formulation for the anode material the total proportion of graphite particles and further electrically conductive components is at least 10% by weight, based on the total weight of the anode material.

The anode ink has a pH of preferably from 5.5 to 8.5 and particularly preferably from 6.5 to 7.5 (determined at 20° C., for example using the pH meter model WTW pH 340i with SenTix RJD probe).

The invention further provides lithium ion batteries comprising a cathode, an anode, a separator and an electrolyte, characterized in that the anode is based on the abovementioned anode material according to the invention.

The production of the anode materials of the invention and lithium ion batteries of the invention can be carried out using the starting materials customary for the respective purpose and the customary methods for producing the anode materials and lithium ion batteries, as are described, for example, in the patent application having the application number DE 102015215415.7, in addition to the redispersible particles from step b) of the process of the invention.

The invention further provides lithium ion batteries comprising a cathode, an anode, a separator and an electrolyte, characterized in that the anode is based on the abovementioned anode material according to the invention;

and in that the anode material of the fully charged lithium ion battery is only partially lithiated.

The present invention further provides methods of operating lithium ion batteries comprising a cathode, an anode, a separator and an electrolyte, characterized in that the anode is based on the abovementioned anode material according to the invention; and

the anode material is only partially lithiated during full charging of the lithium ion battery.

The invention further provides for the use of the anode materials of the invention in lithium ion batteries which are configured so that the anode materials are only partially lithiated in the fully charged state of the lithium ion batteries.

Preference is thus given to the anode material, in particular the redispersible particles according to the invention from step b), being only partially lithiated in the fully charged lithium ion battery. For the purposes of the present invention, the expression fully charged refers to the state of the battery in which the anode material of the battery has its highest loading with lithium. Partial lithiation of the anode material means that the maximum lithium uptake capacity of the silicon particles in the anode material is not fully exhausted. The maximum lithium uptake capacity of the silicon particles generally corresponds to the formula Li_{4.4}Si and is thus 4.4 lithium atoms per silicon atom. This corresponds to a maximum specific capacity of 4200 mAh per gram of silicon.

The ratio of the lithium atoms to the silicon atoms in the anode of a lithium ion battery (Li/Si ratio) can be set, for example, via the flow of electric charge. The degree of lithiation of the anode material or of the silicon particles present in the anode material is proportional to the electric charge which has flowed. In this variant, the capacity of the anode material for lithium is not fully exhausted during charging of the lithium ion battery. This results in partial lithiation of the anode.

In an alternative, preferred variant, the Li/Si ratio of a lithium ion battery is set by cell balancing. Here, the lithium ion batteries are designed so that the lithium uptake capacity of the anode is preferably greater than the lithium release capacity of the cathode. This leads to the lithium uptake capacity of the anode not being fully exhausted, i.e. the anode material being only partially lithiated, in the fully charged battery.

In the partial lithiation according to the invention, the Li/Si ratio in the anode material in the fully charged state of the lithium ion battery is preferably ≤2.2, particularly preferably ≤1.98 and most preferably ≤1.76. The Li/Si ratio in the anode material in the fully charged state of the lithium ion battery is preferably ≥0.22, particularly preferably ≥0.44 and most preferably ≥0.66.

The capacity of the silicon of the anode material of the lithium ion battery is preferably utilized to an extent of ≤50%, particularly preferably ≤45% and most preferably ≤40%, based on a capacity of 4200 mAh per gram of silicon.

The degree of lithiation of silicon or the exploitation of the capacity of silicon for lithium (Si capacity utilization a) can, for example, be determined as described in the patent application having the application number DE 102015215415.7 on page 11, line 4 to page 12, line 25, in particular with the aid of the formulae indicated there for the Si capacity utilization a and the supplementary information under the headings “Determination of the delithiation capacity β” and “Determination of the proportion by weight of Si ω_{S1}” (“incorporated by reference”).

Surprisingly, the redispersible particles according to the invention from step b) of the process of the invention are particularly stable in water, in particular in aqueous ink formulations for anodes of lithium ion batteries, and have little or no tendency to form hydrogen under such conditions. This applies particularly at neutral pH values and at room temperature. This allows processing without foaming of the aqueous ink formulation and production of particularly homogeneous or gas bubble-free anodes. The silicon used as starting material in the process of the invention and also the dried product from step a), on the other hand, generate large amounts of hydrogen in water.

Reducing hydrogen formation in aqueous ink formulations by using silicon particles which have been oxidized on the surface and in this way passivated in respect of reactions with water is frequently taught in the prior art. A disadvantage is that silicon particles having a relatively high degree of oxidation inevitably have a lower content of elemental silicon and thus also a lower storage capacity for lithium ions and therefore give lithium ion batteries having lower energy densities. Furthermore, an increasing silicon dioxide layer increases the initial losses. In addition, silicon dioxide disadvantageously acts as electrochemical insulator. In the approach according to the invention, passivation of the silicon particles by means of oxidation can be dispensed with, so that the energy densities of corresponding lithium ion batteries and the electrochemical conductivity can be increased and the initial losses can also be reduced.

Furthermore, anodes according to the invention display a better electrochemical performance. A further improvement in the cycling stability of the lithium ion batteries can be achieved when the batteries are operated under part load.

The following examples serve to further illustrate the invention:

Examination of Particle Sizes:

The measurement of the particle distribution was carried out by means of static laser light scattering using the Mie model and a Horiba LA 950 in greatly diluted suspension in water. The average particle sizes reported are volume-weighted.

Determination of the Surface Area:

The specific surface area of the particles was determined by nitrogen adsorption using the BET method in accordance with DIN 9277/66131 and 9277/66132.

Determination of the Oxygen Content:

The determination of the oxygen content was carried out on a Leco TCH-600 analyzer. The analysis was carried out via melting of the samples in graphite crucibles under an inert gas atmosphere. Detection was carried out by infrared detection (three measurement cells).

Determination of the Carbon Content:

The determination of the carbon content (C content) of the samples was carried out on a Leco CS 230 analyzer. The analysis was carried out by high-frequency combustion of the sample in a stream of oxygen. Detection was carried out by means of non-dispersive infrared detectors.

Determination of Hydrogen Evolution by GC Measurement (Headspace):

To determine the evolution of hydrogen from the silicon-containing powders, 50 mg of the sample were weighed into a GC headspace bottle (20 ml) and admixed with 5 ml of an Li acetate buffer (pH 7; 0.1 M), the bottle was closed and heated at 80° C. in an aluminum block for 30 minutes while stirring. The determination of the hydrogen content in the gas phase was carried out by means of GC measurement. Detection was carried out by thermal conductivity detection. The proportion of hydrogen was reported in percent by volume of the gas phase. The further gases detected were oxygen, nitrogen and argon.

Determination of the Evolution of Gas by Measurement of the Pressure Buildup in a Closed System:

To determine the evolution of gas by pressure buildup in a closed system, 20 g of the aqueous ink formulation were placed in a tightly closable glass tube which was designed for pressures of up to about 10 bar, the glass vessel was closed and then the pressure change was measured for about 48 hours. Recording was carried out by means of a digital pressure gauge (measurement interval: 10 min).

Method for Carrying Out the Washing-Off Tests:

The washing-off tests were carried out in 50 ml Greiner tubes using a weight of 11 g of the silicon-containing powder and deionized water. In a two-stage washing process, the washing water was firstly added to the powder so that the filled Greiner tube weighed 50 g. The suspension was mixed at 90 rpm for 5 minutes using a mixer (Intelli). The mixture was subsequently centrifuged at 3500 rpm for 20 minutes. The washing water was decanted off and water was added again in a further washing step (total mass 50 g). The procedure described was repeated twice. A change in the C and O contents is determined using a LECO analyzer.

Production of the Si-Containing Suspension for Spray Drying:

In general, the polymer solution was initially charged and subsequently diluted with distilled water while stirring. The total amount of water was selected so that the polymer remained in solution even after adding the milled Si suspension.

The Si-containing suspension was subsequently added while stirring and mixed by means of a high-speed mixer, a precision glass stirrer or a set of rollers. After homogenization, the suspension obtained in this way was passed to spray drying, as described below.

General Procedure for Spray Drying:

The suspension was sprayed under inert conditions (nitrogen; <6% of oxygen) through a two-fluid nozzle (nozzle model 150) on a Büchi dryer model B-290 with InertLoop. As atomizing component, nitrogen was used in a closed circuit. The droplets formed were dried at an inlet temperature of 120° C. For the settings on the dryer, the following parameters were selected: gas flow (flow): 601 l/h; aspirator: 100%; pump rate (feed): 30%. The outlet temperature was in the range from 50 to 60° C. The product was precipitated in a receiver by means of a cyclone.

Production of Electrode Coatings:

The electrode ink was degassed (Speedmixer from Hauschild) and applied by means of a film drawing frame having a gap height of 0.1 mm (Erichsen, model 360) to a copper foil having a thickness of 0.030 mm (Schlenk Metallfolien, SE-Cu58). The anode coating produced in this way was subsequently dried at 50° C. and 1 bar atmospheric pressure for 60 minutes. The average weight per unit area of the dry anode coating was 2.97 mg/cm².

Construction of the Li Ion Cells and Electrochemical Characterization:

The electrochemical tests were carried out in button cells (type CR2032, Hohsen Corp.) in a two-electrode arrangement. The electrode coating described was stamped out as counterelectrode or negative electrode (Dm=15 mm), and a coating based on lithium-nickel-manganese-cobalt oxide 6:2:2 having a content of 94.0% by weight and an average weight per unit area of 14.82 mg/cm² was used as working electrode or positive electrode (Dm=15 mm). A glass fiber filter paper (Whatman, GD Type D) impregnated with 120 μl of electrolyte served as separator (Dm=16 mm). The electrolyte used consisted of a 1.0 molar solution of lithium hexafluorophosphate in a 3:7 (v/v) mixture of fluoroethylene carbonate and ethyl methyl carbonate which had been admixed with 2% by weight of vinylene carbonate. The construction of the cells was carried out in a glove box (<1 ppm of H₂O, O₂; MBraun), and the water content in the dry mass of all components used was below 20 ppm.

The electrochemical testing was carried out at 20° C. Charging of the cell was carried out by the cc/cv (constant current/constant voltage) method at a constant current of 5 mA/g (corresponds to C/25) in the first cycle and of 60 mA/g (corresponds to C/2) in the subsequent cycles and after reaching the voltage limit of 4.2 V at constant voltage until the current went below 1.2 mA/g (corresponds to C/100) or 15 mA/g (corresponds to C/8). Discharging of the cell was carried out by the cc (constant current) method at a constant current of 5 mA/g (corresponds to C/25) in the first cycle and of 60 mA/g (corresponds to C/2) in the subsequent cycles until the voltage limit of 3.0 V had been reached. The specific current selected was based on the weight of the coating of the positive electrode.

Owing to the formulation, the cell balancing of the lithium ion battery corresponded to partial lithiation of the anode.

The discharge capacity of a full cell based on the anode coating is shown as a function of the number of cycles in example 4. The full cell has a reversible initial capacity of 2.02 mAh/cm in the second cycle and after 82 charging/discharging cycles still has 80% of its original capacity.

Anode coatings containing the active material according to the invention display more stable cycling behavior at the same initial capacity.

### EXAMPLE 1: REDISPERSIBLE SI PARTICLES WITH NACMC AS POLYMER

### Example 1a: Spray Drying Products

171.3 g of a 1.4% strength by weight aqueous solution of sodium carboxymethyl cellulose and 328.7 g of an ethanolic suspension of silicon (solids content: 29%; particle size of the silicon particles: d₅₀=800 nm) and an additional 221.2 g of distilled water were used.

The components were mixed as indicated above under the heading “Production of the Si-containing suspension for spray drying”.

### Example 1b: Thermal Treatment of the Spray Drying Products

The powder obtained by spray drying in example 1a was heat treated at an internal temperature of 130° C. in air for 24 hours in a convection drying oven.

### EXAMPLE 2: REDISPERSIBLE SI PARTICLES WITH LIPAA AS POLYMER

### Example 2a: Spray Drying Products

As per example 1a, with the following differences: 35.3 g of a 4% strength by weight aqueous solution of lithium polyacrylate and 164.7 g of the ethanolic suspension of silicon and also an additional 142.9 g of distilled water were used.

### Example 2b: Thermal Treatment of the Spray Drying Products

Identical to the procedure described for example 1b.

It can be seen from table 1 that the powders according to the invention of the examples 1b and 2b display considerably reduced evolution of hydrogen compared to the intermediates of examples 1a and 2a which have not been thermally treated. During the thermal after-treatment, the oxygen content of the particles increased only very slightly and the proportion of carbon decreased to only a very small extent. The BET surface area decreases slightly in a thermal after-treatment.

TABLE 1
Composition of the Si particles and testing of the
evolution of hydrogen (H₂ evolution):

| | | | H₂ evolution | O | | |
|---|---|---|---|---|---|---|
| | | thermal | [% by | content | C content | BET |
| Ex. | Polymer^{a)} | treatment | volume]^{b)} | [%]^{c)} | [%]^{d)} | [m²/g]^{e)} |
| 1a | NaCMC | − | 3.24 | 2.39 | 1.26 | 13.2 |
| 1b | NaCMC | + | 1.43 | 2.94 | 0.95 | 12.1 |
| 2a | LiPAA | − | 3.64 | 3.57 | 1.37 | 12.4 |
| 2b | LiPAA | + | 0.58 | 3.6 | 1.16 | 10.1 |

^{a)}NaCMC: Sodium carboxymethyl cellulose; LiPAA: Lithium poly-acrylate;
^{b)}determined by means of GC measurement (headspace);
^{c)}oxygen content, based on the total weight of the sample; determined by means of Leco TCH-600;
^{d)}carbon content, based on the total weight of the sample; determined by means of Leco CS 230.
^{e)}nitrogen adsorption by the BET method in accordance, with DIN 9277/66131 and 9277/66132.

Washing-Off Tests Using the Si Particles from Examples 1 and 2:

The above-described washing-off test was carried out using the spray drying product of example 1a and the product from the thermal treatment 1b.

The carbon content and oxygen content of the particles were determined before and after carrying out the washing-off test. The results are summarized in table 2.

In the case of the samples of example 1a, which have not been thermally treated, the C/O ratio changes considerably and the carbon content decreases greatly as a consequence of washing. The oxygen content changes only little. Without wishing to be tied to a theory, this can be explained by the washing-off of the polymers resulting in a freely accessible silicon surface which in water experiences oxidation, so that the oxygen introduced via the oxidation largely compensates for a loss of oxygen as a consequence of the washing-off of oxygen-containing polymer NaCMC.

The decreasing carbon content represents the decreasing polymer content on the particles.

In contrast, the C/O ratio of the thermally after-treated sample of example 1b does not change in the washing-off test. The carbon content and also the oxygen content are largely constant, within measurement accuracy.

TABLE 2
Composition of the Si particles before and after
carrying out the washing-off test:

| | before washing-off test | | | after washing-off test | | |
|---|---|---|---|---|---|---|
| Ex. | C [%]^{a)} | O [%]^{b)} | C/O | C [%]^{a)} | O [%]^{b)} | C/O |
| 1a | 1.26 | 2.39 | 0.5 | 0.38 | 2.13 | 0.2 |
| 1b | 0.95 | 2.94 | 0.3 | 0.88 | 2.85 | 0.3 |

^{a)}Carbon content, based on the total weight of the sample; determined by means of Leco CS 230;
^{b)}Oxygen content, based on the total weight of the sample; determined by means of Leco TCH-600.

### COMPARATIVE EXAMPLE 3: ELECTRODE INK

127.54 g of silicon powder from example 1a were mixed with 45.03 g of graphite (KS6L from Imerys) and also 99.4 g of an aqueous LiPAA solution (produced from LiOH and polyacrylic acid) (4% strength by weight; pH 6.9) in a beaker by means of a planetary mixer model LPV 1 G2 from PC Laborsystem. After 60 minutes, a further 127.49 g of the LiPAA solution were added and the mixture was mixed for a further 60 minutes. 45.12 g of water were subsequently added and the mix was mixed for 60 minutes. An ink having a solids content of 42% by weight was obtained. The pH of the ink was 6.92.

### EXAMPLE 4: ELECTRODE INK

127.51 g of silicon powder from example 1b, 45.49 g of graphite (KS6L from Imerys) and also 100.74 g of an aqueous LiPAA solution (produced from LiOH and polyacrylic acid) (4% strength by weight; pH 6.9) were mixed in a beaker using a planetary mixer model LPV 1 G2 from PC Laborsystem. After 60 minutes, a further 134.48 g of the LiPAA solution were added and the mixture was mixed for 60 minutes. 37.82 g of water were subsequently added and the mixture was mixed for 60 minutes. An ink having a solids content of 41.65% by weight was obtained. The pH of the ink was 6.80.

The electrode inks of (comparative) examples 3 and 4 were examined in respect of the evolution of hydrogen therefrom, as described above under the heading “Gas evolution by measurement of the pressure buildup in a closed system”. The results of the tests are summarized in table 3.

TABLE 3
Evolution of hydrogen from the electrode inks of
(comparative) examples 3 and 4:

| | Pressure buildup as a function of the | | | | | |
|---|---|---|---|---|---|---|
| | duration of the test. | | | | | |
| (C) Ex. | 8 h | 16 h | 24 h | 32 h | 40 h | 48 h |
| 3 | 0.47 bar | 0.98 bar | 1.44 bar | 1.88 bar | 2.15 bar | 2.38 bar |
| 4 | 0.00 bar | 0.00 bar | 0.01 bar | 0.02 bar | 0.01 bar | 0.03 bar |

The ink from example 4 showed no pressure change, while the ink from comparative example 3 displayed a large pressure increase.

Testing of Silicon Particles in Lithium Ion Batteries:

The production and testing of the battery was carried out as described above under the headings “Production of electrode coatings” and “Construction of the Li ion cells and electrochemical characterization”. As silicon powder, the Si sources indicated in table 4 were used.

The results of testing are shown in table 4.

TABLE 4
Results of testing of the lithium ion batteries:

| | Number of cycles with ≥80% |
|---|---|
| Si source | capacity retention |
| Si* | 82 |
| Example 1a | 74 |
| Example 1b | 93 |
| Example 2b | 104 |

*Silicon particles having a particle size d50 of 800 nm (i.e. without polymer coating, without thermal treatment).

### COMPARATIVE EXAMPLE 5

Coating of Si Particles with Polyacrylic Acid Salt, without Thermal after-Treatment:

0.65 g of NaOH was dissolved in 500 ml of water, admixed with 1.365 g of polyacrylic acid and stirred until a clear solution had been obtained. The pH of the solution was 6.0.

250 ml of this solution were admixed with 25 g of Si particles from example 1 and stirred at 25° C. for 30 minutes. Solvent was subsequently removed at 150° C. and the solid was dried at 80° C. in a high vacuum.

The particles obtained had a C content of 0.64% and an O content of 23.5%.

5 g of the coated particles obtained were washed with water. The entire coating was removed as a result (determined by determination of the C content of the Si particles). The washing stability is therefore negative.

1. A method for producing redispersible particles based on silicon particles and polymers, comprising:
a) mixing silicon particles having average particle diameters d₅₀ of >600 nm, as determined by static laser light scattering using the Mie model and the measuring instrument Horiba LA 950 using alcohols or water as dispersion medium for the silicon particles, one or more polymers containing functional groups selected from the group consisting of cellulose, cellulose derivatives, polyacrylic acid and salts thereof, polyvinyl esters and polyvinyl alcohols, and also one or more solvents to form a mixture;
b) drying the mixture by spray drying; and
c) thermally treating the mixture at a temperature of from 80° C. to below the decomposition temperature of the polymers.

2. The method for producing redispersible particles based on silicon particles and polymers of claim 1, wherein one or more polymers are selected from the group consisting of cellulose, cellulose derivatives, polyacrylic acid and salts thereof.

3. The method for producing redispersible particles based on silicon particles and polymers of claim 1, wherein the mixture contains from 0.05 to 50% by weight of polymers, based on the dry weight of the mixture.

4. The method for producing redispersible particles based on silicon particles and polymers of claim 1, wherein the mixture contains from 50 to 99.95% by weight of silicon particles, based on the dry weight of the mixture.

5. The method for producing redispersible particles based on silicon particles and polymers of claim 1, wherein in the spray drying in step b), the inlet temperature of the mixture to be dried into the spray drying plant is greater than or equal to the boiling point of the mixture to be dried.

6. The method for producing redispersible particles based on silicon particles and polymers of claim 1, wherein the thermal treatment in step c) is carried out at a temperature of from 90° C. to 250° C.

7. The method for producing redispersible particles based on silicon particles and polymers of claim 1, wherein the thermal treatment in step c) is carried out in air.

8. The method for producing redispersible particles based on silicon particles and polymers of claim 1, wherein the volume-weighted particle size distribution of the redispersible particles from step c) has diameter percentiles d₅₀ of from 600 nm to 15.0 μm.

9. The method for producing redispersible particles based on silicon particles and polymers of claim 1, wherein the redispersible particles from step c) includes from 50 to 99.7% by weight of silicon particles and/or from 0.3 to 50% by weight of polymers, based on the total weight of the redispersible particles.

10. The method for producing redispersible particles based on silicon particles and polymers of claim 1, wherein the redispersible particles from step c) include from 90 to 99% by weight of silicon particles and/or from 1 to 10% by weight of polymers, based on the total weight of the redispersible particles.

11. The method for producing redispersible particles based on silicon particles and polymers of claim 1, wherein the products of step c) have a carbon content which is from 0 to 1% by weight lower compared to the products of step a), in each case based on the total weight of the products.

12. A redispersible particle based on silicon particles and polymers obtainable by the method of claim 1.

13. An anode material for lithium ion batteries comprising
one or more binders,
optionally graphite,
optionally one or more further electrically conductive components,
optionally one or more additives, and
one or more redispersible particles of claim 12.

14. A lithium ion battery comprising:
a cathode,
an anode,
a separator, and
an electrolyte, wherein the anode is based on an anode material as claimed in claim 13.

15. The lithium ion battery of claim 14,
wherein the anode material of the fully charged lithium ion battery is only partially lithiated.

16. The lithium ion battery of claim 15,
wherein the ratio of lithium atoms to silicon atoms in the partially lithiated anode material of the fully charged battery is ≤2.2.

17. The lithium ion battery of claim 15,
wherein the capacity of the silicon of the anode material of the lithium ion battery is utilized to an extent of ≤50%, based on the maximum capacity of 4200 mAh per gram of silicon.
